(19) United States
(12) Patent Application Publication
(10) Pub. No.: US 2001/0001786 A1
(43) Pub. Date: May 24, 2001

(54) ANHYDROUS COMPOSITIONS COMPRISING A PERACID

(75) Inventors: STEFANO SCIALLA, ROME (IT); RAFAELLE SCOCCIANTI, ROME (IT); FULVIA DIFURIA, PADOVA (IT); SANDRO CAMPESTRINI, PADOVANA (IT); GIULIA OTTAVIA BIANCHETTI, ROME (IT)

Correspondence Address: KEVIN L. WAUGH, PATENT DIVISION, THE PROCTER & GAMBLE COMPANY, MIAMI VALLEY LABORATORIES, P O BOX 538707, CINCINNATI, OH, 45253-8707, US

(73) Assignee: Stefano Scialla

(21) Appl. No.: 09/162,982

(22) Filed: Sep. 29, 1998

(30) Foreign Application Priority Data
Sep. 30, 1997 (EP) EP97203000.1

(51) Int. Cl. C11D 1/00; D06L 1/00

(52) U.S. Cl. 510/276

(57) ABSTRACT

The present invention relates to liquid anhydrous compositions comprising a mono- or di-peracid having from 5 to 12 carbon atoms or a mixture thereof, an anhydrous peracid compatible organic solvent and a peracid compatible conventional detergent ingredient. These compositions are stable upon prolonged periods of time as well as in use conditions. These compositions also deliver improved bleaching performance in various washing conditions.

### TECHNICAL FIELD

The present invention relates to anhydrous bleaching compositions comprising preformed peracids (percarboxylic acids). The compositions according to the present invention are particularly suitable to be used in various applications such as in laundry applications, for example as a laundry detergent, a laundry additive or a pretreater, or in household applications as a hard-surface cleaning composition, a toilet bowl cleaning composition, a carpet cleaning composition, a dish-washing cleaning composition, or even an all-purpose disinfecting composition.

### BACKGROUND OF THE INVENTION

A great variety of bleaching compositions have been described in the art. Indeed, bleaching operations using hydrogen peroxide or compounds capable of yielding hydrogen peroxide, i.e. the so-called peroxygen bleaches, have been extensively described in the art.

A major drawback of peroxygen bleaches is that they are less active than chlorine bleaches at low temperatures which are often encountered in modern laundering operations, or in the treatment of hard-surfaces. Thus, peroxygen bleach activators have been developed. Such activators can be transition metal or peracid precursors. Peracid precursors react with hydrogen peroxide to yield peracids. Peracids are the “activated” bleaching species which are efficient at low temperatures.

However, the bleaching performance of such activated bleaching system (i.e., compositions comprising peroxygen bleach and an activator) may be limited by various washing parameters, e.g. pH, dilution, washing time, temperature and the like, that typically influence the kinetic of the reaction between the peroxygen bleach and the activator. Indeed, compositions comprising both a peroxygen bleach and an activator need to meet a balance between shelf-stability of that combination, and its capability to react as fast as possible in water, during the bleaching operation. These two characteristics are somewhat contradictory. This problem is especially acute in liquid aqueous compositions, but it also exists in dry products where shelf stability can become an issue if the composition is subjected to humid environments, as the composition can become damp and may lose some activity.

There is thus a continuous need for the development of compositions which deliver improved bleaching performance when used in various applications, especially under all fabrics washing conditions, while being chemically stable upon prolonged storage periods. The object of the present invention is to provide bleach-containing compositions exhibiting said benefits.

It has now been found that this object is met by formulating a liquid anhydrous bleaching composition comprising a mono- or di-peracid (also called mono- or di-percarboxylic acid) having from 5 to 12 carbon atoms, an anhydrous peracid compatible organic solvent and at least a peracid compatible conventional detergent ingredient. Indeed, it has been found that by incorporating such preformed peracids in liquid anhydrous compositions, effective bleaching performance is delivered both when applied in their neat form and their diluted form on the surface to be bleached (for example dilution may occur simply with water or when the composition of the present invention is used as an additive to conventional liquid or powder laundry detergent compositions in a conventional laundry operation, both in hand washing operations and washing machine operations). Advantageously, effective bleaching performance is delivered with the compositions of the present invention at low and high pH conditions (typically from pH 0.5 to 14), and at low and high temperatures (typically from 10° C. to 90° C.).

The anhydrous compositions of the present invention can be used not only as a laundry detergent or laundry additive, but also in laundry pre-treatment applications, or other laundry applications like dry cleaning, as well as in non-laundry applications, for example for the cleaning of hard surfaces in typical household cleaning processes, toilet bowls, dishes (in both hand washing and dishwashing machines) or even carpets.

A further advantage of the compositions of the present invention is that they are not only chemically stable, but also physically stable upon prolonged storage periods as well as in use conditions. The compositions of the present invention are also environmentally compatible.

Yet another advantage of the compositions of the present invention is that beside the effective bleaching performance delivered when used in various applications like in any conventional laundry operation, these compositions also deliver effective stain removal performance on various stains including greasy stains and/or enzymatic stains.

### BACKGROUND ART

Peracids and processes for manufacturing the same are already known in the art. For example WO 93/0516 discloses a process for the preparation of a dilute aqueous solution comprising a hydroxyaliphatic peroxycarboxylic acid having no more than 7 carbon atoms in which in a first step a concentrated aqueous solution of said peroxycarboxylic acid precursor, i.e., a hydroxyaliphatic carboxylic acid, is mixed with a concentrated hydrogen peroxide solution in presence if necessary of a strong acid as a catalyst, in a second step the mixture is stored until the concentration of said peroxycarboxylic acid has approached its maximum, then the mixture is diluted in water. WO 93/0516 discloses that said hydroxyaliphatic carboxylic acid may be a monocarboxylic acid or preferably a dicarboxylic acid.

EP-A-700 902 discloses a process for the manufacturing of aqueous compositions comprising peracids wherein said process comprises the step of forming said peracids by reacting the corresponding anhydrides with a concentrated hydrogen peroxide solution comprising at least 3 moles of said hydrogen peroxide per molar equivalent of said corresponding anhydride.

EP-A-778 270 discloses a process for manufacturing a monopercarboxylic acid comprising the step of reacting the corresponding dicarboxylic acid with a concentrated solution of hydrogen peroxide in the presence of an aqueous solution of a strong acid for a period not longer than 1 hour and extracting said monopercarboxylic acid formed by for example using organic solvents like ethyl ether, ethyl acetate and the like.

BE-78 8729 discloses the preparation of anhydrous solution of peracid having from 2 to 4 carbon atoms (e.g. peracetic acid). These anhydrous solutions of peracid can be in concentration ranges of 10%-60%. Solvent used is preferably an ester of carboxylic acid having from 4 to 10 carbon atoms (e.g. ethyl acetate, butyl acetate).

BE-78 5280 discloses a process for manufacturing peracid wherein the peracid formed (e.g. perpropionic acid) is extracted in an organic phase comprising an organic solvent so as to provide an organic solution comprising said peracid and said organic solvent. The solvents used may be an aliphatic, cycloaliphatic or aromatic halogenated hydrocarbon.

BE-84 1204 discloses a process for continues preparation of organic solution of percaboxylic acids by reacting an aqueous solution of hydrogen peroxide with the corresponding carboxylic acid in presence of sulphuric acid and extracting the resulting solution with an organic solvent non miscible with water. Solvents used are aliphatic, cycloaliphatic and aromatic hydrocarbons, chlorinated hydrocarbons, and ester of carboxylic acids (e.g., ethyl acetate). The carboxylic acids used may be aliphatic, cycloaliphatic and aromatic carboxylic acids having up to 20 carbon atoms (e.g. suberic acid). In one embodiment of the invention there is obtained a benzene-containing solution comprising from 15% to 25% by weight of perpropionic acid.

U.S. Pat. No. 3,839,216 discloses a process for the production of water free solutions of percarboxylic acids having 2 to 4 carbon atoms comprising extracting the aqueous solution of the percarboxylic acid with a tertiary phosphate ester having 3 to 30 carbon atoms and desorbing the extract with a solvent for said percarboxylic acid selected from the group consisting of hydrocarbyl alkanolates having 4 to 10 carbon atoms, chlorinated aliphatic hydrocarbons and aromatic hydrocarbons, said solvent boiling lover than said phosphate ester.

GB 1 501 356 discloses a continuous process for the preparation of organic solutions of percarboxylic acids starting from hydrogen peroxide and the corresponding acid in the presence of sulphuric acid and extracting the resulting reaction solution with an organic solvent which is miscible with water and concentrating the aqueous raffinate by distillation.

None of these prior art references discloses the liquid anhydrous compositions of the present invention comprising a mono- or di-peracid having from 5 to 12 carbon atoms, an anhydrous peracid compatible organic solvent and a peracid compatible conventional detergent ingredient.

### SUMMARY OF THE INVENTION

The present invention encompasses a liquid anhydrous composition comprising a mono- or di-peracid having from 5 to 12 carbon atoms, an anhydrous peracid compatible organic solvent and at least a peracid compatible conventional detergent ingredient.

The present invention further encompasses processes of treating a surface, e.g. bleaching fabrics, starting from a liquid anhydrous composition as defined herein.

All amounts and percentages are given by weight of the total composition in its neat form unless otherwise stated.

### DETAILED DESCRIPTION OF THE INVENTION

### The Liquid Anhydrous Compositions

The compositions according to the present invention are liquid anhydrous compositions. By “anhydrous”, it is meant herein that the liquid compositions of the present invention are substantially free of water, i.e. the only water that might be present in the compositions herein is the water coming from the raw material used in said compositions. In other words, no water per se is added in the compositions of the present invention. Thus, typically the compositions of the present invention comprise less than 3% by weight of the total composition of total water, preferably less than 2%, more preferably less than 1% and most preferably less than 0.5%.

The compositions according to the present invention must be liquids. As used herein, “liquid” includes “pasty” compositions, and liquid compositions herein preferably have a viscosity of from 1 cps to 10000 cps, preferably from 100 cps to 1000 cps, more preferably from 200 cps to 600 cps, when measured with a Brookfield viscometer at 50 rpm and at 20° C.

As a first essential element, the compositions of the present invention require the presence of a mono- or di-peracid having from 5 to 12 carbon atoms or a mixture thereof.

Suitable monoperacids for use herein are according to the formula:

R₁—COOOH

wherein R₁ is a saturated aliphatic or aromatic, substituted or unsubstituted hydrocarbon chain containing from 4 to 11 carbon atoms, preferably from 5 to 9, more preferably a substituted or unsubstituted aliphatic straight alkyl chain having from 4 to 11 carbon atoms and most preferably from 5 to 9. Particularly preferred substituted hydrocarbon chain R1 of the monoperacids herein is a mono- or poly-carboxylated hydrocarbon chain having from 4 to 11 total carbon atoms, preferably a monocarboxylated alkyl chain having from 5 to 9 carbon atoms.

Preferred monoperacids for use herein include monoperglutaric acid, monoperadipic acid, monoperpimelic acid, monopersuberic acid, 2-methyl perpropionic acid, 2-ethyl perpropionic acid, 2-methyl perhexanoic acid, 2-methyl octanoic acid, or mixtures thereof.

Suitable diperacids for use herein are according to the formula:

HOOOC—Rₐ—COOOH

wherein Rₐ is a saturated aliphatic or aromatic, substituted or unsubstituted hydrocarbon chain containing from 3 to 10 carbon atoms, preferably from 4 to 8, more preferably an aliphatic straight alkyl group having from 3 to 10 carbon atoms and most preferably from 4 to 8.

Preferred diperacids for use herein include 2-ethyl diperglutaric acid, 2-methyl diperglutaric acid, 2,4-dimethyl diperglutaric acid, 2-methyl diperadipic acid, diperadipic acid, 2-methyl dipersuccinic acid, 2,3-dimethyl dipersuccinic acid, 2-methyl diperpimelic acid, diperpimelic acid, 2,6-dimethyl diperpimelic acid, dipersuberic acid or mixtures thereof. Highly preferred herein are dipersuberic acid and diperpimelic acid or mixtures thereof.

For the purpose of the present invention the diperacids herein are highly preferred and especially diperpimelic acid.

Typically, the compositions of the present invention comprise from 0.01% to 15% by weight of the total composition of such a peracid or a mixture thereof, preferably from 0.1% to 10%, more preferably from 0.1% to 5%.

Indeed, it has now been found that the incorporation of such peracids, preferably such diperacids, in an anhydrous liquid bleaching composition comprising an anhydrous peracid compatible organic solvent and at least a peracid compatible conventional detergent ingredient provides chemically and physically stable effective bleaching compositions upon prolonged periods of storage.

By “chemically stable”, it is meant herein that the compositions of the present do not undergo more than 30% loss of available oxygen (often abbreviated to AvO2) when stored for 90 days at 30° C. after having been manufactured, and preferably not more than 20%. The concentration of available oxygen can be measured by chemical titration methods known in the art, such as the iodometric method, thiosulphatimetric method, the permanganometric method and the cerimetric method. Said methods and the criteria for the choice of the appropriate method are described for example in “Hydrogen Peroxide”, W. C. Schumb, C. N. Satterfield and R. L. Wentworth, Reinhold Publishing Corporation, New York, 1955 and “Organic Peroxides”, Daniel Swern, Editor Wiley Int. Science, 1970. An alternative test method to evaluate peracid available oxygen is by chromatography as described in F. Di Furia et. alt., Gas-liquid chromatography method for determination of peracids, Analyst, vol. 109, August 1984, p. 985-987; or ibidem vol. 113, May 1988, p. 793-795.

By “physically stable”, it is meant herein that no phase separation occurs in the compositions according to the present invention for a period of 90 days at 30° C.

By “effective” bleaching performance, it is meant herein that the compositions of the present invention comprising said peracids as described herein, preferably diperacids, deliver improved bleaching performance under various washing conditions, for example when used diluted for example as a laundry additive or neat in a pre-treatment operation, as compared to conventional activated aqueous bleaching compositions comprising both a peroxygen bleach for example hydrogen peroxide and an activator for example tetracetyl ethylene diamine (TAED). Surprisingly, this improved bleaching performance associated to the compositions of the present invention is provided at a significantly reduced total amount of bleaching actives (total level of peracids according to the present invention versus total level of peroxygen bleach in the conventional activated bleaching composition).

The bleaching performance of the compositions of the present invention can be evaluated visually by comparing soiled fabrics (soiled with bleachable stains like tea coffee and the like) that have been treated according to a conventional laundry operation with an anhydrous composition according to the present invention to the same soiled fabrics that have been treated according to the same laundry operation with a reference composition (e.g. aqueous activated hydrogen peroxide compositions).

As a second essential element, the compositions of the present invention comprise an anhydrous peracid compatible organic solvent or a mixture thereof.

Peracid compatible organic solvents are organic solvents which contain no functionalities (such as unsaturation or hydroxyl groups) susceptible of oxidation by the peracid.

By “organic solvent”, it is meant herein any hydrocarbon including aliphatic saturated hydrocarbons or aromatic hydrocarbons that contain or not one or more ester groups.

By “anhydrous”, it is meant herein that the solvents used herein are substantially free of water, i.e., that they typically contain less than 3% by weight of water of the total raw material, preferably less than 2%.

Suitable solvents for use herein include esters, paraffins, or mixtures thereof. Particularly preferred solvents for use herein is an ester or a mixture of esters alone, and more preferably together with a paraffin or a mixture thereof.

The presence of such solvents contributes to the effective stain removal performance delivered by the present compositions on various types of soils including greasy stains (e.g. dirty motor oil), enzymatic stains (e.g. blood) and/or clay stains. Furthermore, the presence of these solvents in the liquid anhydrous compositions of the present invention contributes to the effective bleaching efficacy provided by the peracid. It is speculated that these solvents can be a vehicle to the other active ingredients present in said liquid compositions, helping them to penetrate the stains. Indeed, these solvents can be a vehicle for the peracids.

Suitable esters for use herein are according to the formula R₁-CO-O-R₂ wherein R₁ and R₂ each independently are a linear or branched saturated alkyl group containing from 1 to 10 carbon atoms, preferably from 2 to 8 and more preferably from 2 to 5, or an alkyl substituted or non-alkyl substituted aryl group containing up to 10 carbon atoms, preferably from 3 to 8 and more preferably from 4 to 6 or a mixture thereof.

Particularly preferred ester solvents for use herein include ethyl acetate, ethylbutyrrate, acylated triethyl citrate, propyl acetate, butyl acetate, propyl proplonate, or mixtures thereof. Highly preferred is ethyl acetate.

All type of paraffins can be used herein, both linear and not, containing from 5 to 16 carbons, preferably from 5 to 10, more preferably from 6 to 8. Preferred herein are octane and/or hexane. Octane is commercially available for example from BASF. Paraffines are preferably used in the present invention in combination with a solubilizing agent like the esters herein. Indeed, the solubilizing agent will help to solubilise the peracids in presence of the paraffin. Other solubilizers include toluene, aromatic hydrocarbons in general, chlorinated solvents such us chloroform, di-chloro ethane.

The peracid compatible solvent is present in the compositions herein in amount to balance the compositions of the present invention to a total content of 100% by weight. Typically, the compositions according to the present invention comprise from 99.9% to 95% by weight of the total composition of said peracid compatible organic solvent or a mixture thereof.

In a preferred embodiment of the present invention the esters are used together with the paraffins (typically octane and ethyl acetate). Indeed, the presence of such paraffins further contributes to the stain removal performance of the compositions herein especially on greasy stains (e.g., dirty motor oil). Typically, for optimum stain removal performance as well as optimum bleaching performance a paraffin or mixture thereof is present in the compositions herein at a level of 0.1% to 5% by weight of the total composition, preferably from 0.1% to 3%, and the ester or mixture thereof is present in amount to balance the compositions of the present invention to a total content of 100% by weight.

As a third essential element, the compositions of the present invention comprise at least a peracid compatible conventional detergent ingredient or a mixture thereof.

Peracid compatible detergent ingredients are conventional detergent ingredients which contain no functionalities (such as unsaturation or hydroxyl groups) susceptible of oxidation by the peracid.

By “conventional detergent ingredient”, it is meant herein any ingredient commonly used in the detergent field (e.g., household, laundry, dish, disinfection field) with the exception of water.

Typically, the compositions according to the present invention comprise from 0.01% to 40% by weight of the total composition of a peracid compatible conventional detergent ingredient or a mixture thereof, preferably from 0.1% to 20%, more preferably from 0.1% to 10%, even more preferably from 0.1% to 5% and most preferably from 0.2% to 3%.

Naturally for the purpose of the present invention these conventional detergent ingredients should be delivered in their anhydrous form, i.e., they comprise typically less than 3% by weight of water present in the raw material, preferably less than 2%.

Suitable conventional ingredients for use in the compositions herein include chelating agents, radical scavengers, pigments, surfactants, soil suspending agents, builders, enzymes, dye transfer inhibitors, buffering agents, suds suppressing agents, photobleaching agents, brighteners, dyes, perfumes and the like, and mixtures thereof. Depending on the intended end use of the liquid anhydrous compositions according to the present invention, at least one such ingredient or different combinations of these ingredients may be provided. Preferred suitable conventional detergent ingredients are described in more detail hereinafter. In a preferred embodiment herein, the compositions comprise at least a radical scavenger, and/or a chelant and preferably at least a radical scavenger.

### Radical Scavengers

The compositions herein may comprise a radical scavenger as the preferred peracid compatible conventional detergent ingredient.

Suitable radical scavengers for use herein include the well-known substituted mono-or di hydroxy substituted benzenes and derivatives thereof, alkyl- and aryl carboxylates and mixtures thereof. Preferred radical scavengers for use herein include di-tert-butyl hydroxy toluene (BHT), p-hydroxy-toluene, hydroquinone (HQ), di-tert-butyl hydroquinone (DTBHQ), mono-tert-butyl hydroquinone (MTBHQ), tert-butyl-hydroxy anysole (BHA), p-hydroxy-anysol, benzoic acid, 2,5-dihydroxy benzoic acid, 2,5-dihydroxyterephtalic acid, toluic acid, catechol, t-butyl catechol, 4-allyl-catechol, 4-acetyl catechol, 2-methoxy-phenol, 2-ethoxy-phenol, 2-methoxy-4-(2-propenyl)phenol, 3,4-dihydroxy benzaldehyde, 2,3-dihydroxy benzaldehyde, 1,1,3-tris(2-methyl-4-hydroxy-5-t-butylphenyl) butane, as well as n-propyl-gallate. Highly preferred for use herein are di-tert-butyl hydroxy toluene, which is for example commercially available from SHELL under the trade name IONOL CP® and/or tert-butyl-hydroxy anysole and/or propyl gallate. These radical scavengers contribute to the stability of the peracid bleach-containing compositions herein.

Typically, the compositions according to the present invention comprise up to 5% by weight of the total composition of a radical scavenger, or mixtures thereof, preferably from 0.002% to 1.5% by weight and more preferably from 0.002% to 0.5%.

### Chelating Agents

Suitable chelating agents for use in the compositions according to the present invention, as a peracid compatible conventional detergent ingredient, include any chelating agent known to those skilled in the art and being compatible with peracid. Suitable chelating agents include for example phosphonate chelating agents, polyfunctionally-substituted aromatic chelating agents, amino carboxylate chelating agents, other chelating agents like ethylene diamine N,N′-disuccinic acid and mixtures thereof.

Suitable phosphonate chelating agents for use herein may include ethydronic acid, alkali metal ethane 1-hydroxy diphosphonates as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates (DETPMP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S.S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylate chelating agents for use herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanoldiglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein is diethylene triamine penta acetic acid (DTPA).

The compositions according to the present invention may comprise up to 5% by weight of the total composition of a chelating agent or mixtures thereof, preferably from 0.01% to 3% and more preferably from 0.05% to 1.5%.

### Surfactants

Surfactants may be used in the compositions of the present invention as a conventional detergent ingredients. Surfactants for use herein are those well known in the art and include anionic, nonionic, zwitterionic, amphoteric and cationic surfactants and mixtures thereof. The surfactants suitable for use herein must be compatible with the peracid and commercially available in anhydrous form.

Typically, the compositions herein comprise up to 20% by weight of the total composition of a surfactant or mixtures thereof, preferably from 0.1% to 10% and more preferably from 0.1% to 1%.

In the embodiment where the compositions of the present invention comprise a surfactant, it is highly preferred to also add a radical scavenger. Indeed, the presence of such a radical scavenger contributes to the stability of such compositions.

Suitable anionic surfactants for use herein include sulfonate such as C6-C22 alkyl benzene sulfonates (LAS). The neutralising cation for the anionic synthetic sulfonates is represented by conventional cations which are widely used in detergent technology such as sodium, potassium or alkanolammonium.

Other anionic surfactants useful for detersive purposes can also be used herein. These can include salts (including, for example, sodium, potassium, ammonium, of soap, C₈-C₂₂ primary or secondary alkanesulfonates,-sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates.

Suitable nonionic surfactants for use herein are amine oxide surfactants according to the formula R1R2R3NO, wherein each of R1, R2 and R3 is independently a saturated substituted or unsubstituted, linear or branched alkyl groups of from 1 to 30 carbon atoms, preferably of from 1 to 20 carbon atoms, and mixtures thereof.

Particularly preferred amine oxide surfactants for use according to the present invention are amine oxide surfactants having the following formula R₁R₂R₃NO wherein R1 is a saturated linear or branched alkyl group of from 1 to 30 carbon atoms, preferably of from 6 to 20 carbon atoms, more preferably of from 6 to 16 carbon atoms, and wherein R2 and R3 are independently substituted or unsubstituted, linear or branched alkyl groups of from 1 to 4 carbon atoms, preferably of from 1 to 3 carbon atoms, and more preferably are methyl groups.

Suitable amine oxide surfactants for use herein are for instance pure cut C8 amine oxide, pure cut C10 amine oxide, pure cut C14 amine oxide, natural blend C8-C10 amine oxides as well as natural blend C12-C16 amine oxides. Such amine oxide surfactants may be commercially available from Hoechst or Stephan.

Suitable cationic surfactants for use herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups. The counterion used in said quaternary ammonium compounds is selected from the group of methyl sulfate, or methylsulfonate, and the like.

Particularly preferred cationic surfactants for use herein are trimethyl quaternary ammonium compounds like myristyl trimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

### Soil Suspending Polymers

Any soil suspending polycarboxylate polymer known to those skilled in the art can be used according to the present invention such as homo- or co-polymeric polycarboxylic acids or their salts including polyacrylates and copolymers of maleic anhydride or/and acrylic acid and the like. Indeed, such soil suspending polycarboxylate polymers can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein of monomeric segments, containing no carboxylate radicals such as vinylmethyl ether, styrene, ethylene, etc. is suitable provided that such segments do not constitute more than about 40% by weight.

Particularly suitable polymeric polycarboxylates for use herein can be derived from acrylic acid. Such acrylic acid-based polymers which are useful herein are the salts of polymerized acrylic acid. The average molecular weight of such polymers in the acid form preferably ranges from about 2,000 to 10,000, more preferably from about 4,000 to 7,000 and most preferably from about 4,000 to 5,000. Salts of such acrylic acid polymers can include, for example, the alkali metal, ammonium and substituted ammonium salts. Soluble polymers of this type are known materials. Use of polyacrylates of this type in detergent compositions has been disclosed, for example, in Diehl, U.S. Pat. No. 3,308,067, issued Mar. 7, 1967.

Acrylic/maleic-based copolymers may also be used as a preferred soil suspending polycarboxylic polymer. Such materials include the salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Salts of such acrylic acid/maleic acid copolymers can include, for example, the alkali metal, ammonium and substituted ammonium salts. Soluble acrylate/maleate copolymers of this type are known materials which are described in European Patent Application No. 66915, published Dec. 15, 1982. Particularly preferred is a copolymer of maleic/acrylic acid with an average molecular weight of about 70,000. Such copolymers are commercially available from BASF under the trade name SOKALAN CP5.

Typically, the compositions herein comprise up to 10% by weight of the total composition of a soil suspending polycarboxylate polymer or mixtures thereof, preferably from 0.01% to 8% and more preferably from 0.01% to 2%.

### Builders

The compositions according to the present invention may comprise a builder system, as a conventional detergent ingredient. Any conventional builder system known in the art is suitable for use herein. Suitable builders for use herein include derivatives of succinic acid of the formula R-CH(COOH)CH₂(COOH) wherein R is C₁₀₋₂₀ alkyl or alkenyl, preferably C₁₂₋₁₆, or wherein R can be substituted with sulpho sulphoxyl or sulphone substituents. Specific examples include lauryl succinate, myristyl succinate, palmityl succinate, and/or 2-dodecenylsuccinate.

Other suitable builders are oxodisuccinates and mixtures of tartrate monosuccinic and tartrate disuccinic acid such as described in U.S. Pat. No. 4,663,071.

Further suitable builders for use herein are fatty acid builders including saturated C₁₀₋₁₈ fatty acids, as well as the corresponding soaps. Preferred saturated species have from 12 to 16 carbon atoms in the alkyl chain.

The compositions herein may comprise from 0% to 10%, preferably from 1% to 7% by weight of the total composition of a builder system.

The anhydrous compositions of the present invention are manufactured by extracting a water solution containing the peracids as described herein before, with the anhydrous peracid compatible organic solvent as described herein before. The peracid is previously synthesised by reacting the corresponding mono- or dicarboxylic acid, or anhydride compound with a concentrated solution of hydrogen peroxide in the presence of an aqueous solution of a strong acid, leaving said ingredients in contact for the appropriate period of time before extracting the resulting peracid formed with said anhydrous organic solvent. Then at least a conventional detergent ingredient or a mixture thereof is added to said anhydrous peracid-containing composition.

### Processes of Treating Surfaces

The compositions according to the present invention deliver effective bleaching performance and good cleaning performance (i.e. good stain removal performance), on various stains. Indeed, said compositions are particularly useful as laundry detergent, as laundry pretreaters, i.e., compositions which are dispensed and left to act onto fabrics before they are washed, or as laundry additives to be used together with detergents to boost their performance. Although preferred application of the compositions described herein is laundry application and especially laundry pretreatment, the compositions according to the present invention may also be used as household cleaners in the cleaning of bathroom surfaces or kitchen surfaces, as dishwashing compositions to be used either in the dishwashing machines or by hand, as carpet cleaners to be used either by direct application onto the carpets or in carpet cleaning machines, as toilet bowl cleaners, or as disinfectant products.

In the present invention, the liquid bleaching composition of the present invention needs to be contacted with the surface to be treated.

By “treated”, it is meant bleaching as the compositions of the present invention comprise a peracid bleach as well as cleaning as these compositions also include cleaning ingredients, i.e., at least an anhydrous peracid compatible organic solvent and a peracid compatible conventional detergent ingredient that may further contribute to these benefits.

In a preferred application, the liquid anhydrous bleaching compositions of the present invention needs to be contacted with the fabrics to be treated. This can be done either in a so-called “pre-treatment mode”, where the liquid composition is applied neat onto said fabrics before the fabrics are rinsed, or washed then rinsed, or in a “soaking mode” where the liquid composition is first diluted in an aqueous bath and the fabrics are immersed and soaked in the bath, before they are rinsed, or in a “through the wash mode”, where the liquid composition is added on top of a wash liquor formed by dissolution or dispersion of a typical laundry detergent.

It is also essential in both cases, that the fabrics be rinsed after they have been contacted with said composition, before said composition has completely dried off.

In the pretreatment mode, the process comprises the steps of applying said liquid composition in its neat form onto said fabrics, or at least soiled portions thereof, and subsequently rinsing, or washing then rinsing said fabrics. In this mode, the neat compositions can optionally be left to act onto said fabrics for a period of time ranging from 1 minute to 1 hour, before the fabrics are rinsed, or washed then rinsed, provided that the composition is not left to dry onto said fabrics. For particularly though stains, it may be appropriate to further rub or brush said fabrics by means of a sponge or a brush, or by rubbing two pieces of fabrics against each other.

In another mode, generally referred to as “soaking”, the process comprises the steps of diluting said liquid composition in its neat form in an aqueous bath so as to form a diluted composition. The dilution level of the liquid composition in an aqueous bath is typically up to 1:85, preferably up to 1:50 and more preferably about 1:25 (composition:water). The fabrics are then contacted with the aqueous bath comprising the liquid composition, and the fabrics are finally rinsed, or washed then rinsed. Preferably in that embodiment, the fabrics are immersed in the aqueous bath comprising the liquid composition, and also preferably, the fabrics are left to soak therein for a period of time ranging from 1 minute to 48 hours, preferably from 1 hour to 24 hours.

In yet another mode which can be considered as a sub-embodiment of “soaking”, generally referred to as “bleaching through the wash”, the liquid composition is used as a so-called laundry additive. And in that embodiment the aqueous bath is formed by dissolving or dispersing a conventional laundry detergent in water. The liquid composition in its neat form is contacted with the aqueous bath, and the fabrics are then contacted with the aqueous bath containing the liquid composition. Finally, the fabrics are rinsed.

In another embodiment the present invention also encompasses a process of treating a hard-surface. In such a process a composition, as defined herein, is contacted with the hard-surfaces to be treated. Thus, the present invention also encompasses a process of treating a hard-surface with a composition, as defined herein, wherein said process comprises the step of applying said composition to said hard-surface, preferably only soiled portions thereof, and optionally rinsing said hard-surface.

In the process of treating hard-surfaces according to the present invention the composition, as defined herein, may be applied to the surface to be treated in its neat form or in its diluted form typically up to 200 times their weight of water, preferably into 80 to 2 times their weight of water, and more preferably 60 to 2 times.

By “hard-surfaces”, it is understood any hard-surfaces as mentioned herein before as well as dishes.

Depending on the end-use envisioned, the compositions herein can be packaged in a variety of containers including conventional bottles, bottles equipped with roll-on, sponge, brusher or sprayers.

The present invention will be further illustrated by the following examples.

### EXAMPLES

The compositions hereinafter are according to the present invention and contain the following ingredients in the following proportions:

| Compositions | | | | | | | |
|---|---|---|---|---|---|---|---|
| (% by weight) | I | II | III | IV | V | VI | VII |
| Diperpimelic acid | 1.0 | 2.0 | 3.0 | — | — | — | — |
| Monoperpimelic acid | — | — | — | — | — | 2.0 | — |
| Diperadipic acid | — | — | — | — | 1 0 | — | — |
| Dipersuberic acid | — | — | — | 1.0 | — | — | — |
| BHT | 0.01 | 0.01 | 0.01 | — | 0.01 | — | 0.01 |
| LAS | — | — | — | — | — | — | 1.0 |
| Polyacrylic acid polymer | — | — | — | 0.01 | — | 0.01 | — |
| (MW2000)) | | | | | | | |
| Ethylacetate | balance | — | balance | balance | balance | — | balance |
| Butylacetate | — | balance | — | — | — | balance | — |
| (balance up to 100% by weight) | | | | | | | |
| Compositions | | | | | | | |
| (% by weight) | VIII | IX | X | XI | XII | XIII | XIV |
| Diperpimelic acid | 1 | 2 | 2 | 1 | 4 | 5 | 1 |
| Octane | — | — | — | 1 | 2 | 3 | — |
| Hexane | 1 | 2 | 3 | — | — | 1 | — |
| C12 amine oxide | — | — | — | — | — | — | 1 |
| BHT | 0.01 | 0.01 | 0.02 | 0.05 | 0.1 | 0.5 | 0.01 |

| | |
|---|---|
| Ethylacetate | +E,uns Balance+E,uns |

BHT is Tert butyl hydroxy toluene.
LAS is linear C2-C22 alkyl benzene sulphonate.

The compositions exemplified above are stable upon prolonged periods of time as well as in use conditions. Indeed, they do not undergo any phase separation, nor loss more than 30% by weight of available oxygen after storage of 90 days at 30° C. These compositions also deliver effective bleaching performance in various laundry washing conditions as well as good stain removal performance on stains like lipstick, grease and/or grass or blood.

1. A liquid anhydrous composition comprising:
a mono- or di-peracid having from 5 to 12 carbon atoms or a mixture thereof,
an anhydrous peracid compatible organic solvent and
a peracid compatible conventional detergent ingredient.

2. A composition according to claim 1 wherein said mono-peracid is according to the formula:
R₁—COOOH
wherein R₁ is a saturated aliphatic or aromatic, substituted or unsubstituted hydrocarbon chain containing from 4 to 11 carbon atoms, preferably from 5 to 9, more preferably a substituted or unsubstituted aliphatic straight alkyl group having from 4 to 11 carbon atoms and most preferably from 5 to 9 and more preferably is selected from the group consisting of monoperglutaric acid, monoperadipic acid, monoperpimelic acid, monopersuberic acid, 2-methyl perpropionic acid, 2-ethyl perpropionic acid, 2-methyl perhexanoic acid, 2-methyl octanoic acid, and mixtures thereof.

3. A composition according to any of the preceding claims wherein said di-peracid is according to the formula:
HOOOC—Rₐ—COOOH
wherein Rₐ is a saturated aliphatic or aromatic, substituted or unsubstituted hydrocarbon chain containing from 3 to 10 carbon atoms, preferably from 4 to 8, more preferably an aliphatic straight alkyl group having from 3 to 10 carbon atoms and most preferably from 4 to 8, more preferably is 2-ethyl diperglutaric acid, 2-methyl diperglutaric acid, 2,4-dimethyl diperglutaric acid, 2-methyl diperadipic acid, diperadipic acid, 2-methyl dipersuccinic acid, 2,3-dimethyl dipersuccinic acid, 2-methyl diperpimelic acid, diperpimelic acid, 2,6-dimethyl diperpimelic acid, dipersuberic acid and mixtures thereof and most preferably is diperpimelic acid.

4. A composition according to any of the preceding claims which comprises from 0.01% to 15% by weight of the total composition of said mono- or di-peracid or a mixture thereof, preferably from 0.1% to 10%, more preferably from 0.1% to 5%.

5. A composition according to any of the preceding claims wherein said anhydrous peracid compatible organic solvent is a parraffin, an ester or a mixture thereof, preferably said ester is according to the formula R₁-CO-O-R₂ wherein R₁ and R₂ each independently are a linear or branched saturated alkyl group containing from 1 to 10 carbon atoms, preferably from 2 to 8 and more preferably from 2 to 5 or an alkyl substituted or non-alkyl substituted aryl group containing up to 10 carbon atoms, preferably from 3 to 8 and more preferably from 4 to 6 or a mixture thereof.

6. A composition according to any of the preceding claims wherein said peracid compatible organic solvent is selected from the group consisting of ethyl acetate, ethylbutyrrate, acylated triethyl citrate, propyl acetate, butyl acetate, propyl propionate, octane, hexane and mixtures thereof, preferably is octane, hexane, ethyl acetate or a mixture thereof.

7. A composition according to any of the preceding claims which comprises said anhydrous peracid compatible organic solvent or a mixture thereof, in amount so as to balance said composition to 100% by weight of the total composition.

8. A composition according to any of the preceding claims wherein said peracid compatible conventional ingredient is a radical scavenger, a chelating agent, a peracid compatible surfactant, a soil suspending agent, a builder, pigment, enzyme, dye transfer inhibitor, another anhydrous solvent, buffering agent, suds suppressing agent, photobleaching agent, brightener, dye, perfume or mixtures thereof, more preferably at least a radical scavenger and/or a chelating agent, and most preferably at least a radical scavenger.

9. A composition according to any of the preceding claims which comprises from 0.01% to 40% by weight of the total composition of said peracid compatible conventional detergent ingredient, preferably from 0.1% to 20%.

10. A process of bleaching fabrics which includes the steps of diluting in an aqueous bath a liquid anhydrous composition according to any of the preceding claims, in its neat form, contacting said fabrics with said aqueous bath comprising said liquid composition, and subsequently rinsing, or washing then rinsing said fabrics.

11. A process according to claim 10, wherein the fabrics are left to soak in said aqueous bath comprising said liquid composition for a period of time ranging from 1 minute to 48 hours, preferably from 1 hour to 24 hours.

12. A process according to claim 10, wherein said aqueous bath is formed by dissolving or dispersing a conventional laundry detergent in water.

13. A process of pretreating fabrics which comprises the steps of applying a liquid anhydrous composition according to any of the claims 1 to 9, in its neat form, onto said fabrics, preferably only soiled portions thereof, before rinsing said fabrics, or washing then rinsing said fabrics.

14. A process of treating a hard surface, which include the steps of contacting said surface with the liquid bleaching composition according to any of the claims 1 to 9, in its neat or diluted form, and optionally rinsing said surface.
